(19) United States
(12) Patent Application Publication
(10) Pub. No.: US 2002/0196722 A1
(43) Pub. Date: Dec. 26, 2002

(54) Method and device for increasing CD-R yield

(76) Inventors: Chin Shiong Tsai, Taoyuan Sien (TW); Chien Da Chen, Taoyuan Sien (TW); Chun Wen Chien, Taoyuan Sien (TW)

Correspondence Address: DISCOVISION ASSOCIATES, INTELLECTUAL PROPERTY DEVELOPMENT, 2355 MAIN STREET, SUITE 200, IRVINE, CA, 92614, US

(21) Appl. No.: 10/050,105

(22) Filed: Jan. 18, 2002

(30) Foreign Application Priority Data
Jun. 26, 2001 (TW) 90115408

(51) Int. Cl. G11B 7/0045; G11B 7/125

(52) U.S. Cl. 369/53.34; 369/59.12

(57) ABSTRACT

The invention provides a method for improving the yield of a CD recorder, adjusting the current recordable rate and a write delay table using the data of a write radio frequency profile. The invention also provides a device for improving the yield of a CD recorder, including: a level comparator for respectively comparing the first, second, and third input signal levels with the first, second, and third determined signal levels and outputting the comparison results; a slicer for converting a write radio frequency into the form of binary signal to extract the write radio frequency profile; a phase comparator for comparing the binary write radio frequency profile with a mark signal profile modulated by the eight-to-fourteen modulation and having a phase error output signal; a low-pass filter for eliminating a low frequency baseline fluctuation in the write radio frequency based on the phase error output signal and generating a jitter value; and a yield control microprocessor for adjusting the pickup output power, the recordable delay time, and the rotation rate of spindle motor based on the output results from the level comparator, the jitter value, and an input cyclic redundancy check (CRC).

### BACKGROUND OF THE INVENTION

1. Field of the Invention

The present invention relates to a method and device for increasing CD-R yield, which adjusts recording velocity according to the quality of individual CDs to increase recording yield and quality.

2. Description of Related Art

The CD-R standard defined in the Orange Book by Philips Co. has become widely used in CD technology and among PC users. CD recorders use a laser with high wattage to irradiate the surface of a blank CD, creating readable pit and land signals. For data recording, the surface of the blank CD is coated by sputtering with a dye capable of changing the material properties. The dye can be, for example, cyanine or metal azo.

In CD recorder technology, there are two write modes; Constant Linear Velocity (CLV) and Constant Angular Velocity (CAV). Currently, the recordable success rate depends on the quality of CDs. Even though CDs have the same identified sequence number (the same batch in fabrication), the quality is different for each CD because the formulas of dye coating and sputtering consistency are different every time. These differences further influence the absorption and reflection of laser light by a CD. Especially, the change generated by a dye absorbing and decomposing to the high energy laser light may make the recordable signal transform. For example, the current CLV method runs optical power control (OPC). This utilizes the pickup to monitor and measure the first point A, second point B, third point C of a write radio frequency (WRF) signal, thereby adjusting the appropriate laser power of light. In such a manner, the main problem is that the favorable levels of the WRF's A, B, C signals can not be obtained only by adjusting all CDs with the laser power of light at a fixed velocity. Because the required A, B, C levels of the WRF cannot be adjusted only at a fixed velocity when the difference between the internal and external surfaces of a coated CD by sputtering is very large, for example, on thickness and uniformity. In CAV, the clock of Eight-to-Fourteen Modulation (EFM) (a data modulation technique in the prior art) is changed based on the wobble signal cycle on a CD. In addition, the difference in every tangent velocity on the pickup must have a relative write delay table to be referred in time. The write delay table is individually set up on every rotation rate of different spindle motors. After data is downloaded is into the encoder of a CD recorder to be encoded as an EFM signal, the EFM pattern is written into the CD by controlling the laser energy of the pickup. The reflective RF signal during writing is the WRF signal. The WRF waveform is changed based on the laser velocity, the write delay and the CD temperature. An example of the edge shift by thermal interference when writing data into a CD is shown in FIG. 1 and 2. FIG. 1 is a schematic diagram illustrating the backward-shifting edges of the WRF signal. FIG. 2 is a schematic diagram illustrating the rising edge of WRF signal shifting backward and the falling edge of WRF shifting forward. As shown in FIG. 1 and 2, after the logic change using a radio frequency (RF) as a feedback signal is extracted with the signal processing, the extracted signal is compared to an EFM pattern signal originally encoded within the encoder (not shown) so as to be a reference for measuring the jitter values Error1 and Error2. The WRF signals, i.e., Sliced-WRF 1, 2, are extracted by data slice manner as an actual pattern length recorded on the CD, The phase comparison result of the signals Sliced-WRF 1, 2 and EFM 1,2 is extracted by a lowpass filter as a phase error reference level. When recording, a CD-R or a CD-RW uses the laser energy to heat the dyed surface. Because the edge position of a physical pit signal is based on the initial record temperature, when recording a longer pit signal, the time retaining on the higher temperature is prolonged. Thus, the higher temperature will be kept for a while though the laser energy is cut off. This makes the edges of the signals Sliced-WRF 1 and 2 lag relative to the output signals EFM 1 and 2 of the encoder, respectively. Similarly, when recording a shorter pit signal, the falling edge of the WRF signal will shift earlier, as shown in FIG. 2. The conditions mentioned above can create undesired jitter values Error1 and Error2. This can be improved by adjusting the recordable delay table and the laser energy. If the improvement is inefficient, the method of decreasing the recordable rate is used. Additionally, the values with respect to the WRF levels A, B, C are taken as shown in FIG. 1 according to the Orange Book. The WRF profile is associated with the crystallization depth of the dye used, while the crystallization depth of the dye is associated with the RF profile symmetry sampled on the delay time 3T-11T. When the values on the levels A, B, C can not obtained at a high recordable rate using the write laser power, the recordable rate must be decreased. However, the currently fixed CLV recordable technique cannot achieve the decreased recordable rate request.

### SUMMARY OF THE INVENTION

Accordingly, an object of the invention is to provide a method and device for improving the yield of a CD recorder, which adjusts the recordable rate based on the quality of a CD when recording, thereby increasing the recordable quality and the yield.

The invention provides a method and device for improving the yield of a CD recorder, which adjusts the recordable rate based on the recordable energy, the recordable delay, and the CD's temperature during recording, to optimize the yield. The method includes: determining the number of wrong detection code to be input; decreasing the recordable rate if the number of wrong detection codes to be input is over a first predetermined number; respectively comparing the first, second, third input signal levels with the first, second, third predetermined signal levels; adjusting a write power based on the comparison results; adjusting a write delay based on a jitter input value; adjusting the current recordable rate and a write delay table based on the adjusted write power and write delay to control the rotation rate of spindle motor and the write action of the pickup in the CD recorder. The device includes: a level comparator for respectively comparing the first, second, and third input signal levels with the first, second, and third determined signal levels and outputting the comparison results; a slicer for converting a write radio frequency into the form of a binary signal to extract the write radio frequency profile; a phase comparator for comparing the binary write radio frequency profile with a mark signal profile modulated by the eight-to-fourteen modulation and having a phase error output signal; a low-pass filter for eliminating a low frequency baseline fluctuation in the write radio frequency based on the phase error output signal and generating a jitter value; and a yield control microprocessor for adjusting the pickup output power, the recordable delay time, and the rotation rate of spindle motor based on the output results from the level comparator, the jitter value, and an input cyclic redundancy check (CRC).

### BRIEF DESCRIPTION OF THE DRAWINGS

The invention will become apparent by referring to the following detailed description of a preferred embodiment with reference to the accompanying drawings, wherein:

FIG. 1 is a schematic diagram illustrating the shifting-backward edges of the WRF signal;

FIG. 2 is a schematic diagram illustrating the rising edge of WRF signal shifting backward and the falling edge of WRF shifting forward;

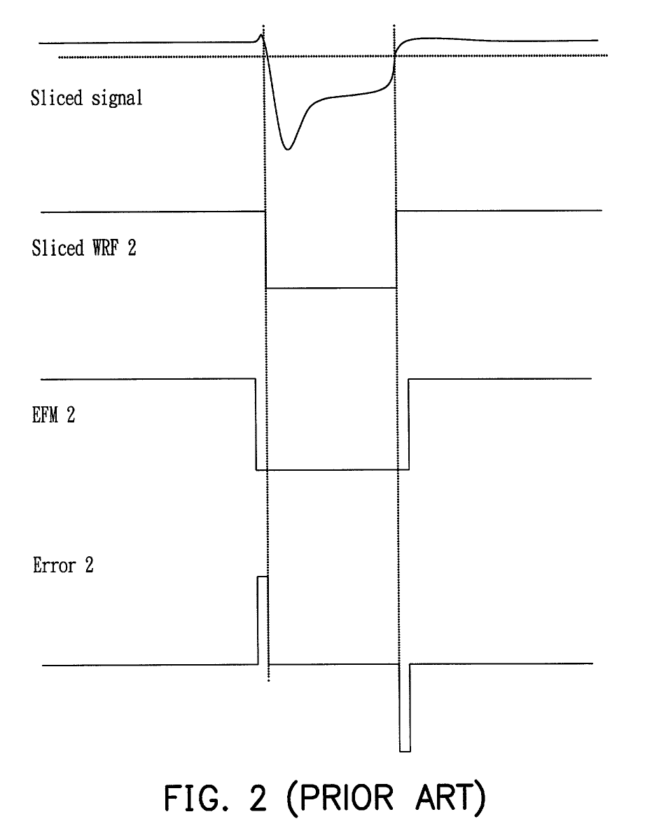

FIG. 3 is a schematic diagram illustrating the inventive structure;

FIG. 4 is a flowchart of the inventive method; and

FIG. 5 is an embodiment of FIG. 4 according to the invention.

### DETAILED DESCRIPTION OF THE INVENTION

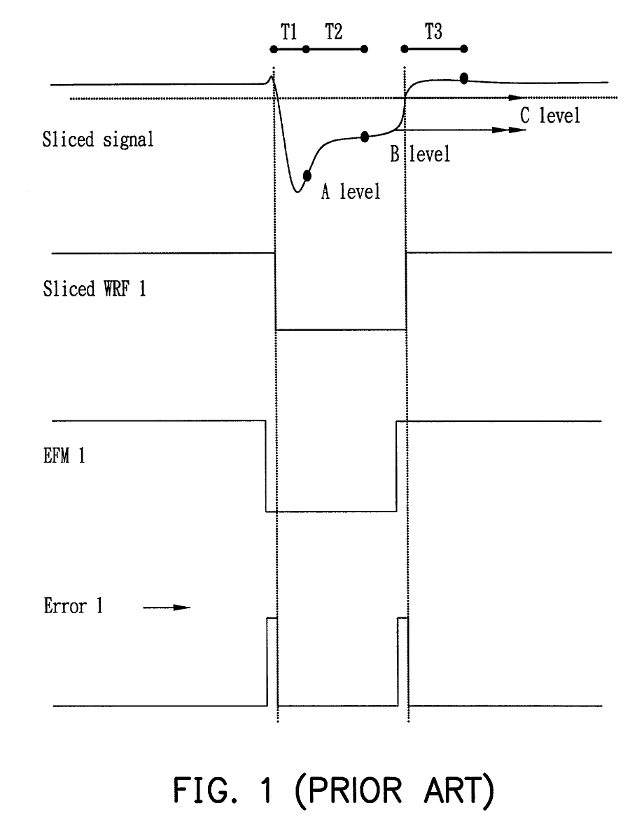

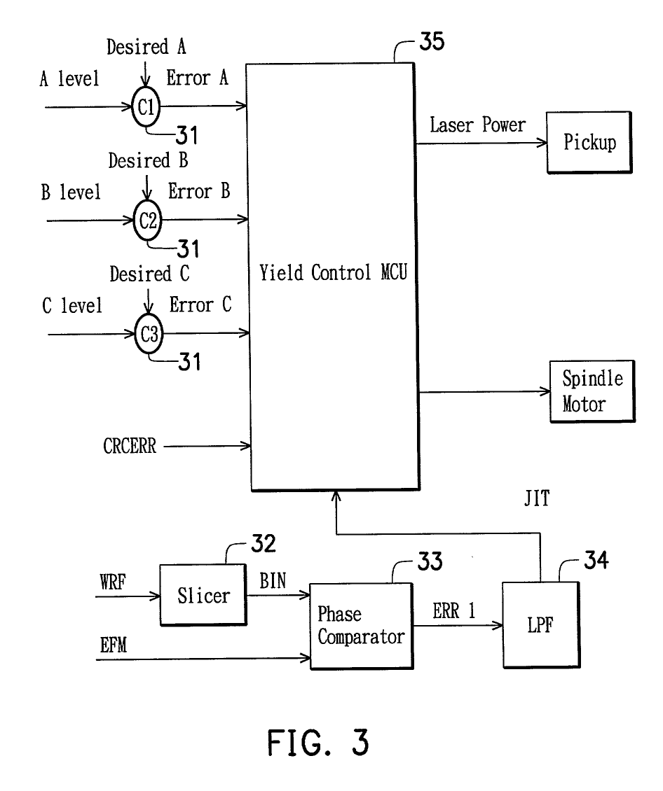

FIG. 3 is a schematic diagram illustrating the inventive structure. In FIG. 3, the device includes: a level comparator 31, a slicer 32, a phase comparator 33, a low-pass filter 34, and a yield control microprocessor 35. As shown in FIG. 3, when recording, the pickup reads three signal levels A, B, C (see FIG. 1 at points A level, B level, C level) according to the Orange Book. The read three levels are input to the respective level comparators C1, C2, C3 (all indicated as 31) to compare with the preset signals Desired A, Desired B, Desired C, and the resulting difference is output as signals Error A, Error B, Error C, respectively. The slicer 32 converts the write radio frequency WRF into the binary form signal BIN. The phase comparator 33 compares the phase of the binary form signal BIN with the phase of the mark signal EFM encoded by an encoder (not shown) using the Eight-to-Fourteen Modulation so as to generate a phase error output signal ERR 1 for adjusting the write delay table. The low-pass filter 34 eliminates the low frequency baseline fluctuation in the signal WRF according to the output signal ERR 1 from the phase comparator 33 so as to generate a jitter value JIT. The yield control microprocessor 35 adjusts the output power of the pickup and the rotation rate of the spindle motor based on the outputs ERROR A, ERROR B, ERROR C of the level comparators 31, the jitter value JIT, and a cyclic redundancy check (CRC) signal CRCERR.

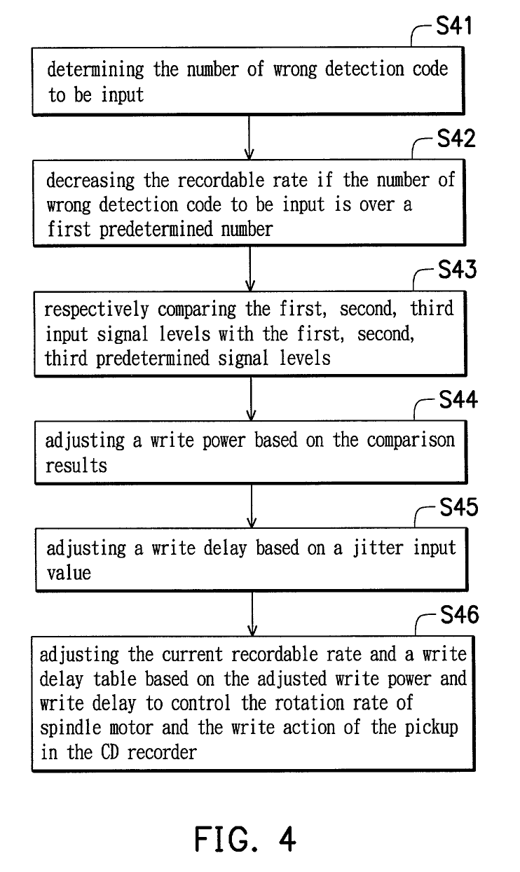

FIG. 4 is a flowchart of the inventive method. In FIG. 4, the method is implemented in the yield control microprocessor 35 of FIG. 3. As shown in FIG. 4, the method includes the following steps. First, the number of wrong detection code to be input is determined (S41). Second, when the number of wrong detection code to be input is over a first predetermined number, the action of decreasing the recordable rate is performed (S42) Third, the first, second, third input signal levels are respectively compared with the first, second, third predetermined signal levels (S43). Fourth, a write power is adjusted based on the comparison results (S44). Fifth, a write delay is adjusted based on a jitter value externally input (S45). Finally, the current recordable rate and a write delay table are adjusted based on the adjusted write power and write delay to control the rotation rate of spindle motor and the write action of the pickup in the CD recorder (S46).

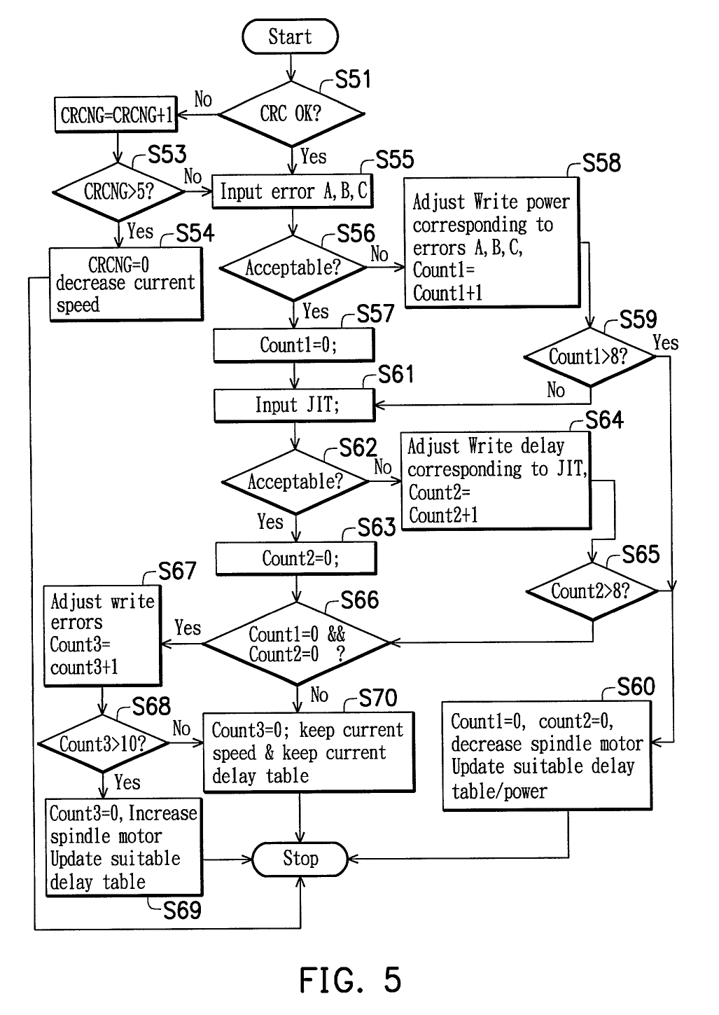

FIG. 5 is an embodiment of FIG. 4. As shown in FIG. 5, in step S51, the yield control microprocessor 35 checks if the error detection code CRC is correct. In step S53, if the code CRC is not correct, the content of a first counter CRCNG is increased by 1 and determines if the content of the first counter CRCNG is greater than a first predetermined value, for example, CRCNG>5. In step S54, if the content of the first counter CRCNG is greater than the first predetermined value, the content of the first counter CRCNG is reset and the current recordable rate is decreased. In step S55, after the predetermined signal levels A, B, C are respectively compared with the signal levels A, B, C sampled as mentioned above, the yield control microprocessor 35 receives the comparison results of errors A, B, C. In step S56, the yield control microprocessor 35 determines if the errors A, B, C are acceptable. In step S57, if the errors A, B, C are acceptable, a second counter Countl is reset. In step S58, if the errors A, B, C are not acceptable, the write power is adjusted based on the errors A, B, C and the content of the second counter Count1 is increased by 1. In step S59, the yield control microprocessor 35 determines if the content of the second counter Count1 is greater than a second predetermined value, for example, Count1>8. In step S60, if the content of the second counter Count1 is greater than the second predetermined value, resetting the second counter Count1 and a third counter Count2, decreasing the rotation rate of the spindle motor and updating a write delay table and write power are performed. In step S61, a jitter value JIT is input externally. In step S62, the yield control microprocessor 35 determines if the input jitter value JIT is acceptable. In step S63, if the input jitter value JIT is acceptable, the third counter Count2 is reset. In step S64, if the input jitter value is not acceptable, the write delay corresponding to the value JIT is adjusted and the third counter Count2 is increased by 1. In step S65, the yield control microprocessor 35 determines if the content of the third counter Count2 is greater than a third predetermined value, for example, Count2>8. If the content of the third counter Count2 is greater than the third predetermined value, the step S60 is performed. Otherwise, as shown in step S66, it is further determined if the second and third counters Count1, Count2 are zero. If one of the counters Count1 and Counts is not zero, the following step S70 is performed. If the second and third counters Count1, Count2 are zero, as shown in step S67, write errors are adjusted and a fourth counter Count3 is increased by 1. In step S68, the yield control microprocessor 35 determines if the content of the fourth counter Count3 is greater than a fourth predetermined value, for example, Count3>10. In step S69, if the content of the fourth counter Count3 is greater than a fourth predetermined value, the fourth counter Count3 is reset, the rotation rate of the spindle motor is increased, and the write delay table is updated In step S70, if the content of the fourth counter Count3 is not greater than a fourth predetermined value, the fourth counter Count3 is reset while the rotation rate of the spindle motor and the write delay table are unchanged.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

what is claimed is:

1. A method for improving the yield of a CD recorder, characterized by adjustment of the current recordable rate and a write delay table using the data of a write radio frequency profile.

2. A method for improving the yield of a CD recorder, comprising the steps:
determining the number of wrong detection code to be input;
decreasing the recordable rate if the number of wrong detection codes to be input is over a first predetermined number;
respectively comparing the first, second, third input signal levels with the first, second, third predetermined signal levels;
adjusting a write power based on the comparison results;
adjusting a write delay based on a jitter input value;
adjusting the current recordable rate and a write delay table based on the adjusted write power and write delay to control the rotation rate of spindle motor and the write action of the pickup in the CD recorder.

3. The method of claim 2, wherein the step of adjusting the current recordable rate and a write delay table comprises the action of keeping the current recordable rate and the write delay table unchanged.

4. The method of claim 2, wherein the step of adjusting the current recordable rate and a write delay table comprises the action of increasing the recordable rate and updating the write delay table.

5. The method of claim 2, wherein the step of adjusting the current recordable rate and a write delay table comprises the action of decreasing the recordable rate and updating the write delay table and a write power.

6. The method of claim 5, wherein a laser source is used to provide the write power.

7. The method of claim 2, further comprising a step of adjusting a write error and accumulating the adjusted number when the number adjusting the write power and write delay is zero.

8. The method of claim 7, further comprising a step of adjusting the current recordable rate and the write delay table based on the adjusted number accumulated.

9. The method of claim 8, wherein the step of adjusting the current recordable rate and write delay table comprises keeping the current recordable rate and the write delay table unchanged.

10. The method of claim 8, wherein the step of adjusting the current recordable rate and write delay table comprises increasing the current recordable rate and updating the write delay table.

11. The method of claim 2, wherein the jitter value is changed based on the temperature of a pickup and the dye and coating thickness used to the surface of a CD.

12. The method of claim 2, wherein the input first, second, and third signal levels are obtained from the standard sampling points of write radio frequency when a laser power positioned in the pickup is used to record the CD.

13. The method of claim 12, wherein the standard sampling points are defined in the Orange Book.

14. The method of claim 2, wherein the write radio frequency profile depends on the dye crystallization depth of a CD.

15. The method of claim 2, wherein the radio frequency is a feedback signal.

16. A device for improving the yield of a CD recorder, comprising:
a level comparator for respectively comparing the first, second, and third input signal levels with the first, second, and third determined signal levels and outputting the comparison results;
a slicer for converting a write radio frequency into the form of binary signal to extract the write radio frequency profile;
a phase comparator for comparing the binary write radio frequency profile with a mark signal profile modulated by the eight-to-fourteen modulation and having a phase error output signal;
a low-pass filter for eliminating a low frequency baseline fluctuation in the write radio frequency based on the phase error output signal and generating a jitter value; and
a yield control microprocessor for adjusting the pickup output power, the recordable delay time, and the rotation rate of the spindle motor based on the output results from the level comparator, the jitter value, and an input cyclic redundancy check (CRC).

17. The device of claim 16, wherein the jitter value is changed based on the temperature of a pickup and the dye and coating thickness used to the surface of a CD.

18. The device of claim 16, wherein the input first, second, and third signal levels are obtained from the standard sampling points of write radio frequency when a laser power positioned in the pickup is used to record the CD.

19. The method of claim 12, wherein the standard sampling points are defined in the Orange Book.

20. The method of claim 2, wherein the write radio frequency profile depends on the dye crystallization depth of a CD.

21. The method of claim 2, wherein the radio frequency signal is a feedback signal.
